(19) United States
(12) Patent Application Publication
(10) Pub. No.: US 2009/0095014 A1
(43) Pub. Date: Apr. 16, 2009

(54) WORKING FLUID OF A BLEND OF 1,1,1,2-TETRAFLUOROETHANE, 1,1,1,2,3,3,3-HEPTAFLUOROPROPANE, AND 1,1,1,3,3,3-HEXAFLUOROPROPANE AND METHOD AND APPARATUS FOR USING

(76) Inventors: Andrew Sun, Suzhou City (CN); Ke Zhang, Shanghai (CN)

Correspondence Address: HONEYWELL INTERNATIONAL INC., 101 COLUMBIA ROAD, P O BOX 2245, MORRISTOWN, NJ, 07962-2245, US

(21) Appl. No.: 12/246,759

(22) Filed: Oct. 7, 2008

Related U.S. Application Data
(60) Provisional application No. 60/979,540, filed on Oct. 12, 2007.

(30) Foreign Application Priority Data
Aug. 20, 2008 (CN) 200810213638.8

(51) Int. Cl. C09K 5/04; F25B 1/00

(52) U.S. Cl. 62/502; 252/67; 252/68; 62/114

(57) ABSTRACT

There is a working fluid for a heating and cooling. The fluid is a blend of from about 1% to about 98% by weight 1,1,1,2,3,3,3-heptafluoropropane, from about 1% to about 98% by weight 1,1,1,3,3,3-hexafluoropropane, and from about 1% to about 98% by weight 1,1,1,2-tetrafluoroethane. The 1,1,1,2,3,3,3-heptafluoropropane, 1,1,1,3,3,3-hexafluoropropane, and 1,1,1,2-tetrafluoroethane are from about 90% or more by weight of the blend. There are also an apparatus that uses the blend and methods for heating and cooling using the blend.

### CROSS REFERENCE TO RELATED APPLICATION

This application claims the benefit of co-pending Provisional patent application Ser. No. 60/979,540 filed Oct. 12, 2007, which is incorporated herein by reference.

### BACKGROUND OF THE INVENTION

1. Field of the Invention

The present invention relates to a working fluid for use in a heating/cooling apparatus. The invention further relates to a working fluid of a blend of 1,1,1,2-tetrafluoroethane (R134a), 1,1,1,2,3,3,3-heptafluoropropane (R227ea), and 1,1,1,3,3,3-hexafluoropropane (R236fa). The invention still further relates to methods for heating or cooling using the working fluid. The invention still yet further relates to an apparatus for heating or cooling having the working fluid.

2. Description of the Related Art

The heat pump technique is a method of upgrading low quality heat energy which cannot be directly utilized, such as heat energy contained in air, soil, surface water and groundwater, as well as industrial waste heat, geothermal energy and solar energy, to a quality level at which said energy can be directly utilized, as well as consuming an amount of high quality heat energy such as electric energy. Using the heat pump technique has a higher efficiency than conventional heating methods, reduces the emission of greenhouse gases, and decreases the thermal pollution caused by the waste heat emission. In order to meet the requirement of higher heat supply temperature in the industry, the heat pump technique is developing towards to a moderate to high temperature (the condensation dew point temperature is 70-100° C.). A deficiency of appropriate working substance is one of the key factors that limit its development. The working substance used in the moderate to high temperature heat pump system in the past includes R11, R113, R114 and the like, which are all of CFC substances, have higher ozone depletion potential (ODP) and global warming potential (GWP), have been banned in the developed countries, and will be banned in the developing countries.

Historically, chlorofluorocarbons such as trichlorofluoromethane (CFC-11), 1,1,2-trichlorotrifluoroethane (CFC-113) and 1,2-dichloro-1,1,2,2-tetrafluoroethane (CFC-114) were used as working fluids in heat pumps, refrigerators, and other heating/cooling devices and machines. Due to elevated levels of Ozone Depletion Potential (ODP) and Global Warming Potential (GMP) the foregoing working fluids exhibit, their use has largely ended. Other frequently used working substances in the current heat pump systems are R22, R407c, R410 or R134a. For the existing heat pump systems using R22, R407c and R410a, the highest obtainable temperature of hot water is 50-55° C. (corresponding to the condensation dew point temperature of 55-60° C.). For existing heat pump systems using R134a, the highest obtainable temperature of hot water is 55-60° C. (corresponding to the condensation dew point temperature of 60-65° C.). If further increasing the temperature, not only will the system behavior be decreased, but also an accident may be caused because the exhaust pressure and the exhaust temperature of the working substance are above the safety limit of the existing heat pump systems.

Chlorofluorocarbons have been replaced in heating and cooling applications by other working fluids that exhibit lower ODP and GMP, such as hydrochlorofluorocarbons and hydrofluorocarbons. Such working fluids include chlorodifluoromethane (R-22), R-407C, R-410A, and 1,1,1,2-tetrafluoroethane (R-134a). R-407C is a blend of difluoromethane (R-32), pentafluoroethane (R-125) and 1,1,1,2-tetrafluoroethane (R-134a). R-410A is a 50:50 mixture by weight of R32 and R125.

The replacement working fluids do not provide the same operating range in middle to high heating temperatures as chlorofluorocarbon working fluids. Of particular interest are middle-high temperatures, i.e., condensing temperatures from 70° C. to 100° C. and high temperatures, i.e., condensing temperatures greater than 100° C. For instance, for R22, R407C and R410A, the highest condensing temperature is 65° C. For R134a, the highest condensing temperature attainable is 73° C. When condensing temperatures exceed the limit, cycle performance deteriorates and risk of accidents increase due to excessive discharge pressures and temperatures (from the compressor).

It would be desirable to have a working fluid that exhibits low ODP and provides excellent thermal performance in the middle and high temperature ranges, particularly in middle-high condensation temperature range of 70° C. to 100° C. It would be further desirable to have a working fluid that is useful in heat pump systems and other heating/cooling machines such as air-conditioning systems and chillers. After considering a combination of factors such as the availability, the cost, the toxicity and the adaptability in the existing heat pump system (compressor) and the like of the working substances, a particular combination as follow is obtained to achieve the present invention.

### SUMMARY OF THE INVENTION

According to the present invention, there is provided a working fluid for heating and cooling. The fluid is a blend of from about 1% to about 98% by weight 1,1,1,2-tetrafluoroethane (R134a), from about 1% to about 98% by weight 1,1,1,2,3,3,3-heptafluoropropane (R227ea), and from about 1% to about 98% by weight 1,1,1,3,3,3-hexafluoropropane (R236fa). The total weight of the 1,1,1,2-tetrafluoroethane, 1,1,1,2,3,3,3-heptafluoropropane, and 1,1,1,3,3,3-hexafluoropropane comprises from about 90% or more by weight of the blend.

Further according to the present invention, there is provided a heating/cooling apparatus. The apparatus has a compressor, a condenser, an expansion element, and an evaporator in series in a cycle. The apparatus further has therein a working fluid of a blend of from about 1% to about 98% by weight of R134a, from about 1% to about 98% by weight of R227ea, and from about 1% to about 98% by weight of R236a. The total weight of the R134a, R227ea, and R236fa comprises from about 90% or more by weight of the blend.

Further according to the present invention, there is provided a method for heating/cooling. The method has the steps of (a) evaporating a working fluid in the form of a lower pressure liquid to form a lower pressure vapor, (b) compressing the lower pressure vapor to a higher pressure vapor, (c) condensing the higher pressure vapor to a higher pressure liquid, (d) expanding the higher pressure liquid to a lower pressure liquid; and (e) recycling the lower pressure liquid to step a). The working fluid includes a blend of from about 1% to about 98% by weight of R134a, from about 1% to about 98% by weight of R227ea, and from about 1% to about 98% by weight of R236fa. The total weight of the R134a, R227ea, and R236fa comprises from about 90% or more by weight of the blend.

Further according to the present invention, there is provided a method of cooling. The method includes the step of evaporating a blend of from about 1% to about 98% by weight of R134a, from about 1% to about 98% by weight of R227ea, and from about 1% to about 98% by weight of R236fa. The total weight of the R134a, R227ea, and R236fa comprises from about 90% or more by weight of the blend.

Further according to the present invention, there is provided a method of heating. The method includes the step of condensing a blend of from about 1% to about 98% by weight of R134a, from about 1% to about 98% by weight of R227ea, and from about 1% to about 98% by weight of R236fa. The total weight of the R134a, R227ea, and R236fa comprises from about 90% or more by weight of the blend.

Another embodiment of the invention relates to a mixed working fluid, comprising from about 1 to about 95 wt % of 1,1,1,2-tetrafluoroethane (R134a), from about 1 to about 98 wt % of 1,1,1,2,3,3,3-heptafluoropropane (R227ea), and from about 1 to about 98 wt % of 1,1,1,3,3,3-hexafluoropropane (R236fa), totaling 100% by weight. This mixed working fluid is preferably a non-azeotropic mixed working substance. The mixed working fluids of the present invention are suitable as the working substance for the heat pump alone or in a combination with suitable lubricant oils, in particular, as the moderate to high temperature heat pump system having a condensation dew point temperature of 70-100° C.

### DETAILED DESCRIPTION OF THE INVENTION

The blend of the present invention has three components, R134a, R227ea, and R236fa. The blend has from about 1 to about 98%, preferably from about 10% to about 85%, and most preferably from about 20% to about 70% by weight of R134a. The blend has from about 1 to about 98%, preferably from about 2% to about 40%, and most preferably from about 10% to about 40% by weight R227ea. The blend has from about 1% to about 98%, preferably from about 2% to about 40%, and most preferably from about 10% to about 40% by weight of R236fa. The total weight of the R134a, R227ea, and R236fa comprises from about 90% or more and preferably from about 95% or more by weight of the blend.

In another embodiment, the mixed working fluid of the present invention is suitable to provide a condensation dew point temperature of from about 70° C. to about 100° C., preferably from about 80° C. to about 100° C., and more preferably from about 90° C. to about 100° C. In another embodiment, the mixed working fluid of the present invention comprises from about 1 wt. % to about 50 wt. % of 1,1,1,2-tetrafluoroethane, from about 1 wt. % to about 98 wt % of 1,1,1,2,3,3,3-heptafluoropropane, and from about 1 wt % to about 98 wt % of 1,1,1,3,3,3-hexafluoropropane, totaling 100% by weight. The mixed working substance is suitable to provide a condensation dew point temperature of from about 80° C. to about 90° C. In a further embodiment, the present invention relates to one of the following particular combinations, wherein the percent is based on the weight, and the sum of the percent by weight of each component of each combination is 100%.

R134a/R227ea/R236fa at from about 1 wt. % to about 25 wt. %/from about 65 wt. % to about 98% wt. %/from about 1 wt. % to about 10 wt. %;

R134a/R227ea/R236fa at from about 1 wt. % to about 30 wt. %/from about 50 wt. % to about 88 wt. %/more than about 10 wt. % to 20 wt. %;

R134a/R227ea/R236fa at from about 1 wt. % to about 40 wt,%/from about 30 wt. % to about 78 wt. %/more than about 20 wt. % to about 30 wt. %; or

R134a/R227ea/R236fa at from about 1 wt. % to about 50 wt. %/from about 1 wt. % to about 68 wt. %/more than about 30 wt. % to about 98 wt. %.

In the context of the present invention, the numerical range of “more than about 10 wt. % to about 20 wt. %” has a same meaning as “10-20%” but excluding the end point of 10%. Other numerical ranges should be understood in a similar manner. In yet another embodiment, the mixed working substance of the present invention comprises from about 1 wt. % to about 20 wt. % of 1,1,1,2-tetrafluoroethane, from about 1 wt. % to about 54 wt. % of 1,1,1,2,3,3,3-heptafluoropropane, and from about 45 wt. % to about 98 wt. % of 1,1,1,3,3,3-hexafluoropropane, totaling 100% by weight. The mixed working substance is suitable to provide a condensation dew point temperature of from about 90° C. to about 100° C. In a yet preferable embodiment, the present invention relates to one of the following particular combination, wherein the percent is based on the weight, and the sum of the percent by weight of each component of each combination is 100%:

R134a/R227ea/R236fa at from about 1 wt. % to about 10 wt. %/from about 40 wt. % to about 54 wt. %/from about 45 wt % to about 50% wt. %;

R134a/R227ea/R236fa at from about 1 wt % to about 18 wt. %/from about 22 wt. % to about 48 wt. %/more than about 50 wt. % to about 60 wt. %; or

R134a/R227ea/R236fa at from about 1 wt. % to about 20 wt. %/from about 1 wt. % to about 38 wt. %/more than about 60 wt. % to about 98 wt. %. As required, without compromising the beneficial effect of the present invention, the blend of the present invention may also have minor amounts, i.e., up to about 10% and preferably up to about 5% by weight of refrigerant components other than R227ea, R236ea, and R134a that exhibit low ODP and GWP. Such components will typically be hydrochlorofluorocarbons and hydrofluorocarbons. Suitable components include, but are not limited to, R-22, difluoromethane (R-32), 1,1-dichloro-2,2,2-trifluoroethane (R123), R-124, pentafluoroethane (R-125), R142b, 1,1-difluoroethane (R152a), 1,1,2-trifluoroethane (R143), 1,1,1-trifluoroethane (R143a), 1,1,2,2,3-pentafluoropropane (R245ca), R-407C, and R-410A, propylene (R1270), propane (R290), octafluoropropane (R218), butane (R600), iso-butane (R600a), 1,1,1,2,3,3-hexafluoropropane (R236ea), 1,1,1,3,3-pentafluoropropane (R245fa) and 1,1-difluoroethane (R152).

The mixed working fluid of the present invention may be used in combination with a lubricant such as a lubricant oils or other conventional additives, or alternatively said mixed working substance itself contains lubricant oils or additives as a component thereof. These lubricant oils or additives are used in their usual amounts without any particular limitation. As the lubricant oils, for example, it may be enumerated the ester synthetic oils (POE, such as EAL Arctic 22CC, manufactured by Mobil), or polyalkylene glycol (PAG)-based lubricant oil.

These additional components may be incorporated as impurity, or be added intentionally, so as to trim the practical performance of the mixed working fluid of the present invention, in order to meet the specific actual demand, but preferably not adding these additional components. The preparation method of the mixed working fluid of the present invention is that all components (and optionally said lubricant oils, additives or additional components and the like) are physically mixed at a normal temperature in a specified mass ratio.

The mixed working fluid of the present invention has the following advantages:

1. All components thereof are of HFC's and therefore ODP thereof equals to zero, and does not destroy the ozone layer.

2. In the condensation dew point temperature range of 70-100° C., the exhaust pressure is not above 26 bar (abs), which is lower than the upper limit of the exhaust pressure of the conventional compressor. Therefore, the mixed working substance of the present invention can be directly used with the existing R134a or R404a compressor, without the need of designing a new compressor, so as to reduce the operation cost and the use cost.

3. A good single stage cycle performance.

Under the specified conditions of the evaporation dew point temperature of 30° C., the condensation dew point of 90° C., the superheat degree of 10° C., and the supercooling degree of 2° C., the highest exhaust temperature is about 120° C., which is below the upper limit of the exhaust temperature of the conventional compressor. Therefore, the mixed working substance of the present invention can be directly used with the existing compressor, without the need of taking particular measures to reduce the exhaust temperature, so as to decrease the operation cost and the use cost.

4. An appropriate boiling point at a normal pressure.

Therefore, during the shutdown, the normal operation of the heat pump system is not affected by the air and the moisture coming into the system which is caused by the negative pressure formed in the system.

5. A proper temperature glide.

Therefore, the influence of the leakage on the variation of the components of the mixed working substance is greatly decreased. Accordingly, even if a part of the gaseous working substance in the heat pump system leaks and components occur to a great variation, it is only necessary to make up a part of the working substance without the need of fully replenishing the whole working substance.

6. A large heating quantity by volume.

Accordingly, under the same heating quantity, the size of the compressor can be reduced, so as to decrease the cost of the heat pump.

7. All components are easily available, inexpensive, very low in toxicity, and non-flammable.

The mixed working substance of the present invention may be applicable to any conventional moderate to high temperature heat pump system excluding segregation-type heat pump system, without further specific limitations besides this. Said moderate to high temperature heat pump system is a vapor compression circulation system, consisting of a compressor, a condenser, a throttling element, an evaporator and the like, which may further comprises a subcooler, an oil separator, a vapor liquid separator and the like. The working principle of the moderate to high temperature heat pump system will be illustrated as below.

First, a low pressure liquid mixed working substance (such as the mixed working substance of the present invention) absorbs the heat from a low temperature heat source (such as water or air) in an evaporator, so as to evaporate into a low pressure superheated gas at a temperature below the temperature of the low temperature heat source to complete the cooling process. Because of the reason of the temperature glide, the evaporator used herein is not a flooded evaporator. Then, the low pressure superheated gas from the evaporator is compressed into a high pressure superheated gas by a compressor. The high pressure superheated gas releases the heat to a high temperature heat source (such as water or air) in a condenser to meet the heating requirement (the heating temperature depends on the condensation dew point temperature of the working substance), and condenses itself into a high pressure liquid. Then, the high pressure liquid is throttled into a low temperature and low pressure gas liquid two-phase mixture by a throttling element. Finally, the throttled low temperature and low pressure gas liquid two-phase mixture comes into the above-mentioned evaporator, thereby, one cycle period is completed.

As the moderate to high temperature heat pump system in which the mixed working substance of the present invention can be used, may be enumerated as follows: a water source or air source high temperature heat pump hot water system (for example, a middle-small high temperature heat pump water heater for meeting the requirement of sauna in hotel or hot water in domestic life, or a large high temperature heat pump hot water unit for providing a mass of the hot water for the industrial production, for example, being useful for heating raw oils at the oilfield, and the like), a water source or air source high temperature heat pump air heating system(for example, a middle-small dryer, e.g. a family dryer or a laundry dryer, or a middle-large drying device, for example, for drying woods, tea, or cloth and silk fabric in the dyehouse, and the like) and the like, wherein the water source may be further replaced with other liquid heat-transferring media, and the air source may be further replaced with other gaseous heat-transferring media, and a high temperature air-conditioning system (which is an air-conditioning system which may be operated at a high temperature, for example, an air-conditioner for the desert zones, an air-conditioner for the crane cab in the steelmaking workshop, and the like). According to the heat pump system of the present invention, a condensation dew point temperature of 70-100° C., preferably 80-100° C., and more preferably 90-100° C. can be provided; therefore, the demand of a higher heating temperature in the industry can be fully met. When the mixed working substance of the present invention is used in the heat pump system, as required, it can be used in a combination with the above-mentioned lubricant oils without any specific limitation.

The mixed working substance of the present invention can be used as a heating/cooling working substance in a cooling/heating process. According to the process, the mixed working substance of the present invention is subject to evaporation to for heating, or to condensation for cooling, or to a combination of evaporation and condensation for a cooling/heating loop. In addition, the present invention also relates to a heat pump system, which uses the above-mentioned mixed working substance of the present invention as a heating/cooling working substance. In the heating/cooling process and the heat pump system, as required, the mixed working substance of the present invention can be used in a combination with lubricant oils.

Another aspect of the present invention is an apparatus and method for heating or cooling employing the blend of R134a, R227ea, and R236fa. The apparatus operates via a vapor compression cycle, which comprises four basic processes: evaporation, compression, condensation and expansion. The apparatus has the following mechanical units: a compressor, a condenser, an expansion element, and an evaporator. The evaporator and condenser are heat exchangers in function. In some instances, the apparatus may have additional optional mechanical units, such as a subcooler, an oil separator, and an accumulator.

Evaporation takes place in the evaporator. In evaporation, heat is absorbed by the blend in the evaporator, i.e., cooling capacity is outputted. In the instance of a heat pump, the heat source for the evaporator may be low-grade thermal energy that is to be converted to high-grade thermal energy. In the instance of a refrigerator or a chiller, the evaporator absorbs heat from its environment and functions as a cooling source. The blend enters the evaporator as a low pressure liquid, absorbs heat at dew point temperature to become a superheated vapor. The dew point temperature is lower than the temperature of the heat source outside the evaporator. A positive evaporating pressure is maintained in the evaporator relative to the outside thereof to prevent air or moisture from entering or infiltrating.

After leaving the evaporator, the low-pressure superheated vapor enters the compressor through a suction line and is compressed to a high pressure. The compressor effects compression through consumption of electrical power or a mechanical energy source, such as a combustion engine. If desired or necessary, vapor temperature at the discharge of the compressor can be controlled via injection of liquid blend into the suction line, regulation of pressure ratio of output to input, or regulation of discharge pressure.

Condensation takes place in the condenser. In condensation, heat is released or devolved by the blend in the condenser, i.e., heat is outputted in the form of high-grade thermal energy (or at least higher grade, i.e., higher temperature, than originally absorbed by the evaporator). The high-pressure superheated vapor discharged by the compressor, enters the condenser, and releases heat to form a high-pressure subcooled liquid. In the present invention, it was found possible to convert 40° C. hot water to get 80° C. hot water at 90° C. dew point at a pressure not exceeding 30 barg (bar gauge).

After leaving the condenser, the high-pressure liquid flows through the expansion element to form a low-pressure liquid due to the pressure drop that takes place at the element. During expansion, some vapor devolves from the liquid taking heat with it causing the temperature of the liquid to drop. Preferably, the enthalpy of the blend is substantially invariable during expansion. If desired or necessary, the high-pressure liquid can be cooled in a subcooler prior to conveyance to the expansion element to reduce the degree of flashing exhibited by the blend upon sudden expansion. After expansion at the expansion element, the low-pressure liquid (and vapor) enters the evaporator and is cycled again.

The heating/cooling apparatus of the present invention can take the form of any conventional vapor compression heating or cooling device or machine known in the art. Examples include heat pump systems, refrigerators, freezers, and chillers. The present invention is particularly useful in heat pump systems. A preferred chiller is a centrifugal chiller

The following are examples of the present invention and are not to be construed as limiting. Unless otherwise indicated, all percentages and parts are by weight.

### EXAMPLES

Examples of working fluids of the present invention were prepared and their operating characteristics evaluated in a heat pump system. Their operating characteristics were compared to reference working fluids R114, R124 and 1-chloro-1,1-difluoroethane (R142b).

The test equipment was a heat pump system. The system had a compressor, condenser, expansion element, and evaporator in series. The tests were carried out at the following conditions: 30° C. dew point temperature in the evaporator, 90° C. dew point temperature in the condenser, 10° C. superheating, 5° C. subcooling, 59.3% isentropic efficiency, an ideal heating coefficient of performance (COP) in the range of 2.6 to 2.92, and a 115° C. discharge temperature at the compressor. Data was collected using Refprop 7.1 software of the National Institute of Standards and Technology (NIST) at the specified conditions.

R134a, R227ea, and R236fa are the components in the working fluids of the examples. The components were physically admixed at ambient temperature at their designated weight percentages. Physical properties of the components are set forth below in Table 1.

TABLE 1
(Physical Data of the Components)

| | | Critical | Critical | | Boiling | | | |
|---|---|---|---|---|---|---|---|---|
| | Chemical | Temperature | Pressure | Molar | Point | | | |
| Component | Description | (° C.) | (bara) | Weight | (° C.) | ODP | GWP | Flammability |
| R134a | 1,1,1,2- | 101.06 | 40.593 | 102.03 | −26.074 | 0 | 1300 | N |
| | Tetrafluoro- | | | | | | | |
| | ethane | | | | | | | |
| R227ea | 1,1,1,2,3,3,3- | 101.65 | 29.26 | 170.03 | −16.45 | 0 | 3500 | N |
| | heptafluoro- | | | | | | | |
| | propane | | | | | | | |
| R236fa | 1,1,1,3,3,3- | 124.92 | 32 | 152.04 | −1.44 | 0 | 9400 | N |
| | hexafluoro- | | | | | | | |
| | propane | | | | | | | |

bara—bar (absolute)
ODP—ozone depletion potential
GWP—global warming potential
N—nonflammable

Results are set forth in Tables 2 to 6. Examples are listed in 10% weight increments. Reference components R114, R124 and R142b were selected for performance comparison due to their relative large volumetric capacity and their non-ODP properties.

TABLE 2
(Comparative Examples 1 to 3 and Examples 1 to 5)

| | | | | | | | | |
|---|---|---|---|---|---|---|---|---|
| Mixture Components | R114* | R124* | R142b* | Ex. 1 | Ex. 2 | Ex. 3 | Ex. 4 | Ex. 5 |

Input

| | | | | | |
|---|---|---|---|---|---|
| R134a (weight %) | 10% | 20% | 30% | 40% | 50% |
| R227ea (weight %) | 80% | 70% | 60% | 50% | 40% |
| R236fa (weight %) | 10% | 10% | 10% | 10% | 10% |
| R134a (mole %) | 15.45% | 29.11% | 41.26% | 52.14% | 61.95% |
| R227ea (mole %) | 74.18% | 61.13% | 49.51% | 39.11% | 29.74% |
| R236fa (mole %) | 10.37% | 9.77% | 9.23% | 8.75% | 8.31% |

CONDITIONS

| | | | | | | | | |
|---|---|---|---|---|---|---|---|---|
| Super Heat ° K | 10 | 10 | 10 | 10 | 10 | 10 | 10 | 10 |
| Subcool ° K | 5 | 5 | 5 | 5 | 5 | 5 | 5 | 5 |
| EVAP Dew Point temp ° C. | 30 | 30 | 30 | 30 | 30 | 30 | 30 | 30 |
| COND Dew Point temp ° C. | 90 | 90 | 90 | 90 | 90 | 90 | 90 | 90 |
| Isentropic efficiency | 0.593 | 0.593 | 0.593 | 0.593 | 0.593 | 0.593 | 0.593 | 0.593 |
| Volume Flow (M\hat{ }3/H) | 23.18 | 23.18 | 23.18 | 23.18 | 23.18 | 23.18 | 23.18 | 23.18 |

OUTPUT

| | | | | | | | | |
|---|---|---|---|---|---|---|---|---|
| Cooling Capacity (KW) | 8.60 | 14.09 | 13.99 | 12.84 | 13.93 | 14.97 | 15.97 | 16.94 |
| Heating Capacity (KW) | 12.67 | 21.05 | 20.31 | 20.88 | 22.48 | 24.00 | 25.44 | 26.81 |
| Power Input (KW) | 4.08 | 6.95 | 6.32 | 8.04 | 8.55 | 9.03 | 9.47 | 9.87 |
| Discharge Temp ° C. | 101.41 | 110.44 | 118.87 | 101.06 | 103.46 | 105.75 | 107.95 | 110.09 |
| Cooling Capacity (KJ/Kg) | 75.53 | 84.08 | 129.83 | 52.18 | 56.61 | 61.14 | 65.86 | 70.80 |
| Heating Capacity (KJ/Kg) | 111.35 | 125.57 | 188.49 | 84.83 | 91.37 | 98.03 | 104.91 | 112.04 |
| Power Input (KJ/Kg) | 35.82 | 41.49 | 58.66 | 32.65 | 34.76 | 36.89 | 39.04 | 41.24 |
| COP for Cooling | 2.11 | 2.03 | 2.21 | 1.60 | 1.63 | 1.66 | 1.69 | 1.72 |
| COP for Heating | 3.11 | 3.03 | 3.21 | 2.60 | 2.63 | 2.66 | 2.69 | 2.72 |
| Volume Capacity (KJ/M3) | 1334.90 | 2188.79 | 2172.40 | 1994.71 | 2163.10 | 2324.42 | 2480.25 | 2630.70 |
| Pressure Ratio | 4.60 | 4.37 | 4.35 | 4.38 | 4.36 | 4.35 | 4.33 | 4.31 |
| Internal Volume Ratio | 4.53 | 4.28 | 3.93 | 5.05 | 4.90 | 4.76 | 4.63 | 4.51 |
| BP ° C. @ 1 bar | 3.25 | −12.28 | −9.43 | −17.44 | −18.89 | −20.16 | −21.25 | −22.18 |
| COND Pressure bar | 11.56 | 19.46 | 17.09 | 24.02 | 25.33 | 26.50 | 27.52 | 28.43 |
| COND Temp Glide | 0.00 | 0.00 | 0.00 | 0.56 | 0.72 | 0.75 | 0.70 | 0.64 |
| EVAP Temp Glide | 0.00 | 0.00 | 0.00 | 0.38 | 0.56 | 0.64 | 0.65 | 0.63 |
| ODP | 1.00 | 0.02 | 0.07 | 0.00 | 0.00 | 0.00 | 0.00 | 0.00 |
| GWP | 9800.00 | 620.00 | 2400.00 | 3771.85 | 3435.87 | 3136.85 | 2869.00 | 2627.70 |

*not an example of the present invention
M\hat{ }3/H—cubic meters per hour
KW—kilowatts
KJ—kilojoules
Kg—kilograms
M³—cubic meters
COND—condenser
EVAP—evaporator
° K—degrees Kelvin
BP—boiling point
temp—temperature
temp glide—glide temperature
COP—coefficient of performance

TABLE 3
(Examples 6 to 13)

| | | | | | | | | |
|---|---|---|---|---|---|---|---|---|
| Mixture Components | Ex. 6 | Ex. 7 | Ex. 8 | Ex. 9 | Ex. 10 | Ex. 11 | Ex. 12 | Ex. 13 |

Input

| | | | | | | | | |
|---|---|---|---|---|---|---|---|---|
| R134a (weight %) | 60% | 70% | 80% | 10% | 20% | 30% | 40% | 50% |
| R227ea (weight %) | 30% | 20% | 10% | 70% | 60% | 50% | 40% | 30% |
| R236fa (weight %) | 10% | 10% | 10% | 20% | 20% | 20% | 20% | 20% |
| R134a (mole %) | 70.83% | 78.91% | 86.29% | 15.28% | 28.81% | 40.86% | 51.66% | 61.41% |
| R227ea (mole %) | 21.25% | 13.53% | 6.47% | 64.20% | 51.86% | 40.86% | 31.00% | 22.11% |
| R236fa (mole %) | 7.92% | 7.56% | 7.24% | 20.51% | 19.33% | 18.28% | 17.33% | 16.48% |

Conditions

| | | | | | | | | |
|---|---|---|---|---|---|---|---|---|
| Super Heat ° K | 10 | 10 | 10 | 10 | 10 | 10 | 10 | 10 |
| Subcool ° K | 5 | 5 | 5 | 5 | 5 | 5 | 5 | 5 |
| EVAP Dew Point Temp ° C. | 30 | 30 | 30 | 30 | 30 | 30 | 30 | 30 |
| COND Dew Point Temp ° C. | 90 | 90 | 90 | 90 | 90 | 90 | 90 | 90 |
| Isentropic efficiency | 0.593 | 0.593 | 0.593 | 0.593 | 0.593 | 0.593 | 0.593 | 0.593 |
| Volume Flow (M\hat{ }3/H) | 23.18 | 23.18 | 23.18 | 23.18 | 23.18 | 23.18 | 23.18 | 23.18 |

Output

| | | | | | | | | |
|---|---|---|---|---|---|---|---|---|
| Cooling Capacity KW | 17.87 | 18.76 | 19.61 | 12.81 | 13.86 | 14.87 | 15.83 | 16.76 |
| Heating Capacity KW | 28.10 | 29.33 | 30.49 | 20.63 | 22.18 | 23.64 | 25.03 | 26.34 |
| Power Input KW | 10.23 | 10.57 | 10.88 | 7.83 | 8.32 | 8.77 | 9.19 | 9.58 |
| Discharge Temp ° C. | 112.18 | 114.24 | 116.28 | 101.46 | 103.91 | 106.26 | 108.51 | 110.70 |
| Cooling Capacity (KJ/Kg) | 75.94 | 81.26 | 86.76 | 55.01 | 59.66 | 64.39 | 69.27 | 74.33 |
| Heating Capacity (KJ/Kg) | 119.42 | 127.05 | 134.89 | 88.62 | 95.47 | 102.40 | 109.50 | 116.81 |
| Power Input (KJ/Kg) | 43.49 | 45.78 | 48.13 | 33.61 | 35.81 | 38.01 | 40.23 | 42.48 |
| COP for Cooling | 1.75 | 1.78 | 1.80 | 1.64 | 1.67 | 1.69 | 1.72 | 1.75 |
| COP for Heating | 2.75 | 2.78 | 2.80 | 2.64 | 2.67 | 2.69 | 2.72 | 2.75 |
| Volume Capacity (KJ/M3) | 2775.39 | 2913.97 | 3046.20 | 1988.98 | 2152.82 | 2308.84 | 2458.88 | 2603.38 |
| Press. Ratio | 4.30 | 4.29 | 4.28 | 4.43 | 4.42 | 4.41 | 4.39 | 4.38 |
| Internal Volume Ratio | 4.40 | 4.30 | 4.21 | 5.05 | 4.91 | 4.77 | 4.65 | 4.53 |
| BP Temp ° C. @ 1 bar | −22.96 | −23.62 | −24.16 | −16.06 | −17.43 | −18.63 | −19.68 | −20.58 |
| COND Pressure bar | 29.23 | 29.94 | 30.57 | 23.37 | 24.63 | 25.74 | 26.74 | 27.62 |
| COND Temp Glide | 0.57 | 0.50 | 0.43 | 0.77 | 0.99 | 1.06 | 1.04 | 0.99 |
| EVAP Temp Glide | 0.59 | 0.54 | 0.50 | 0.59 | 0.82 | 0.96 | 1.03 | 1.04 |
| ODP | 0.00 | 0.00 | 0.00 | 0.00 | 0.00 | 0.00 | 0.00 | 0.00 |
| GWP | 2409.18 | 2210.36 | 2028.70 | 4374.06 | 4006.82 | 3679.59 | 3386.17 | 3121.57 |

TABLE 4
(Examples 14 to 21)

| | | | | | | | | |
|---|---|---|---|---|---|---|---|---|
| Mixture Components | Ex. 14 | Ex. 15 | Ex. 16 | Ex. 17 | Ex. 18 | Ex. 19 | Ex. 20 | Ex. 21 |

Input

| | | | | | | | | |
|---|---|---|---|---|---|---|---|---|
| R134a (weight %) | 60% | 70% | 10% | 20% | 30% | 40% | 50% | 60% |
| R227ea (weight %) | 20% | 10% | 60% | 50% | 40% | 30% | 20% | 10% |
| R236fa (weight %) | 20% | 20% | 30% | 30% | 30% | 30% | 30% | 30% |
| R134a (mole %) | 70.24% | 78.28% | 15.12% | 28.52% | 40.47% | 51.19% | 60.88% | 69.66% |
| R227ea (mole %) | 14.05% | 6.71% | 54.44% | 42.78% | 32.38% | 23.04% | 14.61% | 6.97% |
| R236fa (mole %) | 15.71% | 15.01% | 30.44% | 28.70% | 27.16% | 25.77% | 24.51% | 23.37% |

Conditions

| | | | | | | | | |
|---|---|---|---|---|---|---|---|---|
| Super Heat ° K | 10 | 10 | 10 | 10 | 10 | 10 | 10 | 10 |
| Subcool ° K | 5 | 5 | 5 | 5 | 5 | 5 | 5 | 5 |
| EVAP Dew Point Temp | 30 | 30 | 30 | 30 | 30 | 30 | 30 | 30 |
| ° C. | | | | | | | | |
| COND Dew Point Temp | 90 | 90 | 90 | 90 | 90 | 90 | 90 | 90 |
| ° C. | | | | | | | | |
| Isentropic efficiency | 0.593 | 0.593 | 0.593 | 0.593 | 0.593 | 0.593 | 0.593 | 0.593 |
| Volume Flow (M\hat{ }3/H) | 23.18 | 23.18 | 23.18 | 23.18 | 23.18 | 23.18 | 23.18 | 23.18 |

Output

| | | | | | | | | |
|---|---|---|---|---|---|---|---|---|
| Cooling Capacity KW | 17.66 | 18.51 | 12.72 | 13.75 | 14.71 | 15.64 | 16.53 | 17.39 |
| Heating Capacity KW | 27.59 | 28.78 | 20.30 | 21.80 | 23.20 | 24.53 | 25.80 | 27.01 |
| Power Input KW | 9.94 | 10.27 | 7.58 | 8.05 | 8.49 | 8.89 | 9.27 | 9.61 |
| Discharge Temp ° C. | 112.84 | 114.94 | 101.89 | 104.40 | 106.81 | 109.12 | 111.36 | 113.54 |
| Cooling Capacity (KJ/Kg) | 79.57 | 84.98 | 58.25 | 63.14 | 68.05 | 73.07 | 78.24 | 83.56 |
| Heating Capacity (KJ/Kg) | 124.35 | 132.10 | 92.96 | 100.12 | 107.30 | 114.60 | 122.08 | 129.75 |
| Power Input (KJ/Kg) | 44.78 | 47.12 | 34.71 | 36.98 | 39.25 | 41.54 | 43.85 | 46.19 |
| COP for Cooling | 1.78 | 1.80 | 1.68 | 1.71 | 1.73 | 1.76 | 1.78 | 1.81 |
| COP for Heating | 2.78 | 2.80 | 2.68 | 2.71 | 2.73 | 2.76 | 2.78 | 2.81 |
| Volume Capacity (KJ/M3) | 2742.25 | 2875.31 | 1976.05 | 2134.84 | 2285.22 | 2429.35 | 2567.96 | 2701.21 |
| Press. Ratio | 4.37 | 4.35 | 4.50 | 4.49 | 4.48 | 4.47 | 4.45 | 4.44 |
| Internal Volume Ratio | 4.43 | 4.33 | 5.06 | 4.92 | 4.80 | 4.68 | 4.57 | 4.46 |
| BP Temp ° C. @ 1 bar | −21.36 | −22.02 | −14.45 | −15.75 | −16.91 | −17.93 | −18.83 | −19.62 |
| COND Pressure bar | 28.40 | 29.10 | 22.63 | 23.83 | 24.90 | 25.87 | 26.73 | 27.50 |
| COND Temp Glide | 0.93 | 0.87 | 1.08 | 1.36 | 1.47 | 1.48 | 1.45 | 1.40 |
| EVAP Temp Glide | 1.03 | 1.01 | 0.87 | 1.18 | 1.37 | 1.48 | 1.54 | 1.55 |
| ODP | 0.00 | 0.00 | 0.00 | 0.00 | 0.00 | 0.00 | 0.00 | 0.00 |
| GWP | 2881.74 | 2663.37 | 4963.34 | 4566.22 | 4211.94 | 3893.94 | 3606.90 | 3346.52 |

TABLE 5
(Examples 22 to 29)

| | | | | | | | |
|---|---|---|---|---|---|---|---|
| Mixture Components | Ex. 22 | Ex. 23 | Ex. 25 | Ex. 26 | Ex. 27 | Ex. 28 | Ex. 29 |

Input

| | | | | | | | |
|---|---|---|---|---|---|---|---|
| R134a (weight %) | 10% | 20% | 30% | 40% | 50% | 10% | 20% |
| R227ea (weight %) | 50% | 40% | 30% | 20% | 10% | 40% | 30% |
| R236fa (weight %) | 40% | 40% | 40% | 40% | 40% | 50% | 50% |
| R134a (mole %) | 14.96% | 28.23% | 40.08% | 50.73% | 60.35% | 14.80% | 27.95% |
| R227ea (mole %) | 44.88% | 33.88% | 24.05% | 15.22% | 7.24% | 35.53% | 25.16% |
| R236fa (mole %) | 40.16% | 37.89% | 35.86% | 34.05% | 32.40% | 49.67% | 46.89% |

Conditions

| | | | | | | | |
|---|---|---|---|---|---|---|---|
| Super Heat ° K | 10 | 10 | 10 | 10 | 10 | 10 | 10 |
| Subcool ° K | 5 | 5 | 5 | 5 | 5 | 5 | 5 |
| EVAP Dew Point Temp ° C. | 30 | 30 | 30 | 30 | 30 | 30 | 30 |
| COND Dew Point Temp ° C. | 90 | 90 | 90 | 90 | 90 | 90 | 90 |
| Isentropic efficiency | 0.593 | 0.593 | 0.593 | 0.593 | 0.593 | 0.593 | 0.593 |
| Volume Flow (M\hat{ }3/H) | 23.18 | 23.18 | 23.18 | 23.18 | 23.18 | 23.18 | 23.18 |

Output

| | | | | | | | |
|---|---|---|---|---|---|---|---|
| Cooling Capacity KW | 12.60 | 13.59 | 14.52 | 15.41 | 16.27 | 12.43 | 13.39 |
| Heating Capacity KW | 19.91 | 21.34 | 22.69 | 23.98 | 25.20 | 19.45 | 20.84 |
| Power Input KW | 7.31 | 7.76 | 8.18 | 8.57 | 8.93 | 7.02 | 7.45 |
| Discharge Temp ° C. | 102.34 | 104.91 | 107.37 | 109.74 | 112.03 | 102.77 | 105.39 |
| Cooling Capacity (KJ/Kg) | 61.84 | 66.96 | 72.04 | 77.20 | 82.46 | 65.69 | 71.04 |
| Heating Capacity (KJ/Kg) | 97.73 | 105.19 | 112.61 | 120.11 | 127.74 | 102.79 | 110.56 |
| Power Input (KJ/Kg) | 35.89 | 38.23 | 40.57 | 42.92 | 45.28 | 37.10 | 39.52 |
| COP for Cooling | 1.72 | 1.75 | 1.78 | 1.80 | 1.82 | 1.77 | 1.80 |
| COP for Heating | 2.72 | 2.75 | 2.78 | 2.80 | 2.82 | 2.77 | 2.80 |
| Volume Capacity (KJ/M3) | 1956.31 | 2109.99 | 2254.78 | 2393.14 | 2526.09 | 1930.78 | 2079.68 |
| Press. Ratio | 4.57 | 4.57 | 4.56 | 4.55 | 4.53 | 4.64 | 4.64 |
| Internal Volume Ratio | 5.07 | 4.94 | 4.82 | 4.71 | 4.60 | 5.08 | 4.96 |
| BP Temp ° C. @ 1 bar | −12.71 | −13.98 | −15.11 | −16.12 | −17.03 | −10.95 | −12.19 |
| COND Pressure bar | 21.80 | 22.95 | 23.99 | 24.94 | 25.78 | 20.93 | 22.03 |
| COND Temp Glide | 1.45 | 1.81 | 1.97 | 2.01 | 1.99 | 1.85 | 2.31 |
| EVAP Temp Glide | 1.18 | 1.56 | 1.82 | 1.98 | 2.07 | 1.46 | 1.92 |
| ODP | 0.00 | 0.00 | 0.00 | 0.00 | 0.00 | 0.00 | 0.00 |
| GWP | 5540.10 | 5114.40 | 4734.19 | 4392.56 | 4083.91 | 6104.73 | 5651.70 |

TABLE 6
(Examples 30 to 36)

| | | | | | | | |
|---|---|---|---|---|---|---|---|
| Mixture Components | Ex. 30 | Ex. 31 | Ex. 32 | Ex. 33 | Ex. 34 | Ex. 35 | Ex. 36 |

Input

| | | | | | | | |
|---|---|---|---|---|---|---|---|
| R134a (weight %) | 40% | 10% | 20% | 30% | 10% | 20% | 10% |
| R227ea (weight %) | 10% | 30% | 20% | 10% | 20% | 10% | 10% |
| R236fa (weight %) | 50% | 60% | 60% | 60% | 70% | 70% | 80% |
| R134a (mole %) | 50.28% | 14.65% | 27.68% | 39.34% | 14.50% | 27.41% | 14.35% |
| R227ea (mole %) | 7.54% | 26.37% | 16.61% | 7.87% | 17.40% | 8.22% | 8.61% |
| R236fa (mole %) | 42.18% | 58.98% | 55.72% | 52.80% | 68.10% | 64.37% | 77.04% |

Conditions

| | | | | | | | |
|---|---|---|---|---|---|---|---|
| Super Heat ° K | 10 | 10 | 10 | 10 | 10 | 10 | 10 |
| Subcool ° K | 5 | 5 | 5 | 5 | 5 | 5 | 5 |
| EVAP Dew Point Temp ° C. | 30 | 30 | 30 | 30 | 30 | 30 | 30 |
| COND Dew Point Temp ° C. | 90 | 90 | 90 | 90 | 90 | 90 | 90 |
| Isentropic efficiency | 0.593 | 0.593 | 0.593 | 0.593 | 0.593 | 0.593 | 0.593 |
| Volume Flow (M\hat{ }3/H) | 23.18 | 23.18 | 23.18 | 23.18 | 23.18 | 23.18 | 23.18 |

Output

| | | | | | | | |
|---|---|---|---|---|---|---|---|
| Cooling Capacity KW | 15.15 | 12.24 | 13.17 | 14.04 | 12.02 | 12.93 | 11.77 |
| Heating Capacity KW | 23.37 | 18.96 | 20.30 | 21.56 | 18.45 | 19.75 | 17.92 |
| Power Input KW | 8.23 | 6.73 | 7.13 | 7.52 | 6.43 | 6.82 | 6.15 |
| Discharge Temp ° C. | 110.34 | 103.16 | 105.84 | 108.42 | 103.51 | 106.24 | 103.82 |
| Cooling Capacity (KJ/Kg) | 81.58 | 69.68 | 75.28 | 80.73 | 73.70 | 79.58 | 77.64 |
| Heating Capacity (KJ/Kg) | 125.90 | 107.98 | 116.06 | 123.97 | 113.15 | 121.57 | 118.17 |
| Power Input (KJ/Kg) | 44.32 | 38.30 | 40.78 | 43.25 | 39.45 | 41.99 | 40.54 |
| COP for Cooling | 1.84 | 1.82 | 1.85 | 1.87 | 1.87 | 1.90 | 1.92 |
| COP for Heating | 2.84 | 2.82 | 2.85 | 2.87 | 2.87 | 2.90 | 2.92 |
| Volume Capacity (KJ/M3) | 2352.12 | 1900.55 | 2045.27 | 2180.05 | 1866.31 | 2007.68 | 1828.30 |
| Press. Ratio | 4.63 | 4.71 | 4.71 | 4.71 | 4.77 | 4.78 | 4.82 |
| Internal Volume Ratio | 4.73 | 5.08 | 4.97 | 4.86 | 5.08 | 4.97 | 5.07 |
| BP Temp ° C. @ 1 bar | −14.33 | −9.22 | −10.45 | −11.57 | −7.56 | −8.78 | −5.98 |
| COND Pressure bar | 23.96 | 20.02 | 21.09 | 22.07 | 19.12 | 20.15 | 18.24 |
| COND Temp Glide | 2.60 | 2.24 | 2.81 | 3.09 | 2.54 | 3.26 | 2.70 |
| EVAP Temp Glide | 2.46 | 1.66 | 2.20 | 2.60 | 1.72 | 2.35 | 1.63 |
| ODP | 0.00 | 0.00 | 0.00 | 0.00 | 0.00 | 0.00 | 0.00 |
| GWP | 4882.28 | 6657.62 | 6178.44 | 5749.52 | 7199.13 | 6694.94 | 7729.60 |

The saturation pressure for the blend examples ranged from 18 to 30 bara (bar absolute) at a 90° C. dew point temperature. This is desirable because such blends can be employed as is in existing commercial compressors that are retrofitted for the use of R22, R134a and R404A, which also exhibit similar saturation pressures.

The blend examples also exhibited low boiling points at a pressure of one bar absolute. Low boiling points ensure that a heat pump system can hold a positive pressure not only during operation but also off-line and during shipping and storage. A positive system pressure prevents infiltration of air and moisture into the heat pump system and allows condensing pressure to be favorably controlled. For all the examples of this invention, the boiling point at one bar was lower than −5° C., so positive pressure could be maintained in heat pump system at high temperature conditions. If ambient temperatures fall below dew point temperature of the blend (e.g., during winter temperatures), then the heat pump should not be charged with the blend during shipping or storage.

Examples 3, 4, 11, 12, 19, 20, 21 and 26 demonstrated effective performance and efficiency at high dew point condenser temperatures.

The working fluids of the following Examples and the Comparative Examples are fed respectively into a testing unit based on ZB92KCE totally enclosed scroll compressor (manufactured by the Emerson Company), and their performances are tested in the specified conditions. The lubricant oil used in the compressor is EAL Arctic 22CC (Mobil). According to the first recommended combination manner specified in the Table 1A of GB/T5773-2004 “The method of performance test for positive displacement refrigerant compressors”, i.e., Method A+Method (F, G and K), the various performances of the working substances of the Examples and the Comparative Examples, which corresponds to the refrigerant named in the above standard, are test. The parameters are calculated as follows. The compression ratio=exhaust pressure/suction pressure, wherein: The exhaust pressure (bar) is directly measured by a pressure sensor at the exhaust port of the compressor (or the inlet of the condenser); The suction pressure (bar) is directly measured by a pressure sensor at the suction port of the compressor (or the outlet of the evaporator); The exhaust temperature (° C. ) is directly measured by a temperature sensor at the exhaust port of the compressor. The heating efficiency=the heating quantity by mass/the power consumption by mass, wherein: The heating quantity by mass(kJ/kg)=the heating quantity/the mass flow of the mixed working substance, wherein the heating quantity is measured with the method G, and the mass flow of the mixed working substance is measured with the method F. The power consumption by mass (kJ/kg)=the power of the compressor/the mass flow of the mixed working substance, wherein, the power of the compressor is measured with a power meter. The heating quantity by volume (kJ/m3)=the heating quantity by mass/the exhaust quantity of the compressor, wherein, the exhaust quantity of the compressor is obtained by directly measuring the volume flow at the suction port of the compressor. The boiling point (° C. ) is expressed as the dew point temperature at 1 atm. The superheat degree (° C. )=the bubble point temperature in the condenser−the outlet temperature of the condenser. The supercooling degree (° C. )=the suction temperature of the evaporator−the dew point temperature in the evaporator. The condensation temperature glide (° C. )=the dew point temperature in the condenser−the bubble point temperature in the condenser. The evaporation temperature glide (° C. )=the dew point temperature in the evaporator−the inlet temperature of the evaporator. The ODP of the mixed working substance=Σ the ODP of each component×the mass percent of said component relative to the total of the mixed working substance, and The GWP of the mixed working substance=Σ the GWP of each component×the mass percent of said component relative to the total of the mixed working substance, wherein the GWP and the ODP of each component are shown in Table 1A.

### Examples 1A-10A

1,1,1,2-tetrafluoroethane(R134a), 1,1,1,2,3,3,3-heptafluoropropane(R227ea),and 1,1,1,3,3,3-hexafluoropropane (R236fa) are physically mixed in a liquid phase according to the component ratio in Table 2 to give the mixed working substances of Examples 1A-10A, the performances of which are respectively tested in the specified conditions of the condensation dew point temperature of 80° C., the superheat degree of 10° C., the supercooling degree of 2° C., and the evaporation dew point temperature of 30° C. The results are shown in Table 2A.

### Comparative Examples 1A and 2A

R134a (1,1,1,2-tetrafluoroethane, pure compound) is used as Comparative Examples 1A, and R114 (tetrafluorodichloroethane, pure compound), which is a currently frequently used working substance in the heat pump, is used as Comparative Examples 2. These performances are respectively tested in the specified conditions of the condensation dew point temperature of 80° C., the superheat degree of 10° C., the supercooling degree of 2° C., and the evaporation dew point temperature of 30° C. The results are shown in Table 2A.

### Examples 11A -25A

1,1,1,2-tetrafluoroethane(R134a), 1,1,1,2,3,3,3-heptafluoropropane(R227ea), and 1,1,1,3,3,3-hexafluoropropane (R236fa) are physically mixed in a liquid phase according to the component ratio in Table 3A to give the mixed working substances of Examples 11A-25A of the present invention, the performances of which are respectively tested in the specified conditions of the condensation dew point temperature of 90° C., the superheat degree of 10° C., the supercooling degree of 2° C., and the evaporation dew point temperature of 30° C. The results are shown in Table 3A.

### Comparative Examples 3A and 4A

R134a is used as Comparative Example 3A, and R114 is used as Comparative Example 4A. These performances are respectively tested in the specified conditions of the condensation dew point temperature of 90° C., the superheat degree of 10° C., the supercooling degree of 2° C., and the evaporation dew point temperature of 30° C. The results are shown in Table 3A.

### Examples 26A-35A

1,1,1,2-tetrafluoroethane(R134a), 1,1,1,2,3,3,3-heptafluoropropane (R227ea),and 1,1,1,3,3,3-hexafluoropropane (R236fa) are physically mixed in a liquid phase according to the component ratio in Table 4A to give the mixed working substances of Examples 26A-35A of the present invention, the performances of which are respectively tested in the specified conditions of the condensation dew point temperature of 100° C., the superheat degree of 10C, the supercooling degree of 2° C., and the evaporation dew point temperature of 40° C. The results are shown in Table 4A.

### Comparative Examples 5A and 6A

R134a is used as Comparative Example 5A, and R114 is used as Comparative Example 6A. These performances are respectively tested in the specified conditions of the condensation dew point temperature of 100° C., the superheat degree of 10° C., the supercooling degree of 2° C., and the evaporation dew point temperature of 40° C. The results are shown in Table 4A.

By comparing the results of the Examples with those of the Comparative Examples, it can be clear that the mixed working substance of the present invention is suitable to provide a condensation dew point temperature of 70-100° C., can be directly used in the existing heat pump system, and has no safety problems such as a too high exhaust pressure and a too high exhaust temperature.

TABLE 2A

| | | Example | Example | Example | Example | Example | Example |
|---|---|---|---|---|---|---|---|
| | | 1A | 2A | 3A | 4A | 5A | 6A |
| Component ratio | R134a | 1% | 1% | 95% | 70% | 60% | 20% |
| | R227ea | 98% | 1% | 3% | 20% | 20% | 50% |
| | R236fa | 1% | 98% | 2% | 10% | 20% | 30% |

| | | | | | | |
|---|---|---|---|---|---|---|
| Exhaust temperature (° C.) | 88.27 | 92.03 | 106.60 | 102.55 | 101.33 | 93.82 |
| Heating quantity by mass (kJ/kg) | 82.61 | 122.27 | 148.70 | 133.05 | 130.48 | 106.63 |
| Power consumption by mass (kJ/kg) | 26.40 | 34.72 | 43.73 | 39.61 | 38.79 | 32.28 |
| Heating efficiency | 3.13 | 3.52 | 3.40 | 3.36 | 3.36 | 3.30 |
| Heating quantity by volume (kJ/m³) | 3272.06 | 2547.21 | 5258.72 | 4777.86 | 4501.44 | 3605.63 |
| Compression ratio | 3.52 | 3.89 | 3.43 | 3.47 | 3.52 | 3.62 |
| Boiling point (° C.) | −16.75 | −2.17 | −25.94 | −23.64 | −21.36 | −15.70 |
| Exhaust pressure (bar) | 18.68 | 12.69 | 26.00 | 24.26 | 22.95 | 19.18 |
| Suction pressure (bar) | 0.10 | 0.51 | 7.59 | 6.99 | 6.51 | 1.73 |
| Condensation temperature glide | 5.31 | 3.26 | 0.11 | 0.64 | 1.20 | 5.30 |
| (° C.) | | | | | | |
| Evaporation temperature glide (° C.) | 0.05 | 0.24 | 0.11 | 0.62 | 1.18 | 1.43 |
| ODP | 0 | 0 | 0 | 0 | 0 | 0 |
| GWP | 3529 | 9227 | 1451 | 2210 | 2881 | 4566 |

| | | Example | Example | Example | Example | Comparative | Comparative |
|---|---|---|---|---|---|---|---|
| | | 7A | 8A | 9A | 10A | Example 1A | Example 2A |
| Component | R134a | 40% | 30% | 10% | 20% | | |
| ratio | R227ea | 20% | 20% | 30% | 10% | | |
| | R236fa | 40% | 50% | 60% | 70% | | |

| | | | | | | |
|---|---|---|---|---|---|---|
| exhaust | 98.66 | 97.11 | 92.98 | 95.79 | 107.37 | 92.08 |
| temperature (° C.) | | | | | | |
| heating quantity by | 126.37 | 124.45 | 114.12 | 127.51 | 151.78 | 114.34 |
| mass (kJ/kg) | | | | | | |
| power consumption | 37.27 | 36.44 | 33.41 | 36.50 | 44.54 | 31.02 |
| by mass (kJ/kg) | | | | | | |
| heating efficiency | 3.39 | 3.42 | 3.42 | 3.49 | 3.41 | 3.69 |
| heating quantity by | 3918.40 | 3619.41 | 3110.97 | 3216.41 | 5352.19 | 2020.69 |
| volume (kJ/m³) | | | | | | |
| Compression ratio | 3.65 | 3.72 | 3.77 | 3.81 | 3.42 | 3.71 |
| Boiling point (° C.) | −16.11 | −13.30 | −9.19 | −8.77 | −26.36 | 3.25 |
| Exhaust pressure | 20.04 | 18.47 | 16.03 | 16.09 | 26.33 | 9.31 |
| (bar) | | | | | | |
| Suction pressure | 2.49 | 3.06 | 2.67 | 3.80 | 7.70 | 2.51 |
| (bar) | | | | | | |
| Condensation | 5.49 | 4.97 | 4.25 | 4.22 | 0.00 | 0.00 |
| temperature glide | | | | | | |
| (° C.) | | | | | | |
| Evaporation | 2.30 | 2.64 | 1.99 | 2.79 | 0.00 | 0.00 |
| temperature | | | | | | |
| glide (° C.) | | | | | | |
| ODP | 0 | 0 | 0 | 0 | 0 | 1 |
| GWP | 4393 | 5247 | 6658 | 6695 | 1300 | 9800 |

TABLE 3A

| | | Example | Example | Example | Example | Example | Example | Example | Example | Example |
|---|---|---|---|---|---|---|---|---|---|---|
| | | 11A | 12A | 13A | 14A | 15A | 16A | 17A | 18A | 19A |
| Component ratio | R134a | 1% | 10% | 20% | 25% | 1% | 20% | 30% | 1% | 30% |
| | R227ea | 98% | 80% | 70% | 65% | 88% | 60% | 50% | 78% | 40% |
| | R236fa | 1% | 10% | 10% | 10% | 11% | 20% | 20% | 21% | 30% |

| | | | | | | | | | |
|---|---|---|---|---|---|---|---|---|---|
| Exhaust temperature (° C.) | 98.09 | 100.73 | 103.16 | 104.33 | 98.48 | 103.66 | 106.03 | 98.90 | 106.63 |
| Heating quantity by mass | 70.86 | 79.43 | 85.79 | 89.00 | 73.94 | 90.05 | 96.80 | 77.62 | 101.87 |
| (kJ/kg) | | | | | | | | | |
| Power consumption by mass | 30.05 | 32.67 | 34.78 | 35.84 | 30.84 | 35.84 | 38.03 | 31.76 | 39.28 |
| (kJ/kg) | | | | | | | | | |
| Heating efficiency | 2.36 | 2.43 | 2.47 | 2.48 | 2.40 | 2.51 | 2.55 | 2.44 | 2.59 |
| Heating quantity by volume | 2806.46 | 3036.62 | 3281.32 | 3398.57 | 2799.36 | 3250.52 | 3474.20 | 2782.23 | 3422.43 |
| (kJ/m³) | | | | | | | | | |
| Compression ratio | 4.35 | 4.38 | 4.36 | 4.36 | 4.39 | 4.43 | 4.41 | 4.45 | 4.48 |
| Boiling point (° C.) | −16.75 | −17.36 | −18.84 | −19.51 | −15.73 | −17.37 | −18.60 | −14.42 | −16.88 |
| Exhaust pressure (bar) | 23.11 | 24.03 | 25.37 | 25.98 | 22.64 | 24.66 | 25.78 | 22.05 | 24.93 |
| Suction pressure (bar) | 5.31 | 5.49 | 5.81 | 5.96 | 5.154234 | 5.57 | 5.85 | 4.96 | 5.56 |
| Condensation temperature | 0.07 | 0.58 | 0.75 | 0.77 | 0.16 | 1.02 | 1.08 | 0.33 | 1.49 |
| glide (° C.) | | | | | | | | | |
| Evaporation temperature | 0.03 | 0.34 | 0.50 | 0.55 | 0.11 | 0.75 | 0.88 | 0.26 | 1.27 |
| glide (° C.) | | | | | | | | | |
| ODP | 0 | 0 | 0 | 0 | 0 | 0 | 0 | 0 | 0 |
| GWP | 3529 | 3772 | 3436 | 3282 | 4176 | 4007 | 3680 | 4808 | 4212 |

| | | Example | Example | Example | Example | Example | Example | Comparative | Comparative |
|---|---|---|---|---|---|---|---|---|---|
| | | 20A | 21A | 22A | 23A | 24A | 25A | Example 3A | Example 4A |
| Component | R134a | 35% | 1% | 1% | 50% | 30% | 10% | | |
| ratio | R227ea | 35% | 68% | 1% | 10% | 20% | 20% | | |
| | R236fa | 30% | 31% | 98% | 40% | 50% | 70% | | |

| | | | | | | | | |
|---|---|---|---|---|---|---|---|---|
| Exhaust | 107.82 | 99.33 | 101.66 | 111.99 | 107.83 | 103.44 | 119.60 | 101.41 |
| temperature (° C.) | | | | | | | | |
| Heating quantity by | 105.42 | 81.94 | 112.41 | 122.15 | 113.05 | 108.39 | 139.46 | 107.95 |
| mass (kJ/kg) | | | | | | | | |
| Power consumption by | 40.42 | 32.80 | 39.87 | 45.29 | 41.94 | 39.47 | 51.65 | 35.82 |
| mass (kJ/kg) | | | | | | | | |
| Heating efficiency | 2.61 | 2.50 | 2.82 | 2.70 | 2.70 | 2.75 | 2.70 | 3.01 |
| Heating quantity by | 3525.86 | 2757.38 | 2341.78 | 3742.45 | 3287.74 | 2743.62 | 4917.79 | 1907.63 |
| volume (kJ/m³) | | | | | | | | |
| Compression ratio | 4.48 | 4.51 | 4.87 | 4.53 | 4.64 | 4.77 | 4.21 | 4.60 |
| Boiling point (° C.) | −17.42 | −12.87 | −2.17 | −17.02 | −13.30 | −7.54 | −26.36 | 3.25 |
| Exhaust pressure (bar) | 25.43 | 21.36 | 15.89 | 25.80 | 23.05 | 19.13 | 32.44 | 11.56 |
| Suction pressure (bar) | 5.68 | 4.73 | 3.26 | 5.69 | 4.97 | 4.01 | 7.70 | 2.51 |
| Condensation | 1.50 | 0.64 | 0.45 | 2.00 | 2.54 | 2.56 | 0.00 | 0.00 |
| temperature glide (° C.) | | | | | | | | |
| Evaporation | 1.33 | 0.46 | 0.18 | 1.94 | 2.09 | 1.58 | 0.00 | 0.00 |
| temperature glide (° C.) | | | | | | | | |
| ODP | 0 | 0 | 0 | 0 | 0 | 0 | 0 | 0 |
| GWP | 4049 | 5425 | 9227 | 4084 | 5247 | 7199 | 1300 | 9800 |

TABLE 4A

| | | Example | Example | Example | Example | Example | Example |
|---|---|---|---|---|---|---|---|
| | | 26A | 27A | 28A | 29A | 30A | 31A |
| Component ratio | R134a | 1% | 5% | 10% | 1% | 10% | 18% |
| | R227ea | 54% | 47% | 40% | 48% | 30% | 22% |
| | R236fa | 45% | 48% | 50% | 51% | 60% | 60% |

| | | | | | | |
|---|---|---|---|---|---|---|
| Exhaust temperature (° C.) | 110.11 | 111.23 | 112.57 | 110.26 | 112.83 | 114.88 |
| Heating quantity by mass (kJ/kg) | 75.47 | 79.56 | 84.03 | 78.53 | 89.52 | 95.17 |
| Power consumption by mass (kJ/kg) | 31.59 | 32.84 | 34.21 | 32.24 | 35.35 | 37.23 |
| Heating efficiency | 2.39 | 2.42 | 2.46 | 2.44 | 2.53 | 2.56 |
| Heating quantity by volume (kJ/m³) | 3095.74 | 3194.49 | 3322.83 | 3086.43 | 3292.03 | 3489.69 |
| Compression ratio | 4.23 | 4.25 | 4.27 | 4.26 | 4.32 | 4.33 |
| Boiling point (° C.) | −10.51 | −10.57 | −10.90 | −9.48 | −9.19 | −10.19 |
| Exhaust pressure (bar) | 25.02 | 25.36 | 25.91 | 24.43 | 24.82 | 25.91 |
| Suction pressure (bar) | 5.92 | 5.97 | 6.07 | 5.73 | 5.74 | 5.99 |
| Condensation temperature glide | 0.78 | 1.05 | 1.39 | 0.94 | 1.74 | 2.11 |
| (° C.) | | | | | | |
| Evaporation temperature glide (° C.) | 0.56 | 0.78 | 1.02 | 0.65 | 1.20 | 1.54 |
| ODP | 0 | 0 | 0 | 0 | 0 | 0 |
| GWP | 6267 | 6237 | 6105 | 6619 | 6658 | 6270 |

| | | Example | Example | Example | Example | Comparative | Comparative |
|---|---|---|---|---|---|---|---|
| | | 32A | 33A | 34A | 35A | Example 5A | Example 6A |
| Component | R134a | 1% | 20% | 1% | 10% | | |
| ratio | R227ea | 38% | 10% | 1% | 10% | | |
| | R236fa | 61% | 70% | 98% | 80% | | |

| | | | | | | |
|---|---|---|---|---|---|---|
| Exhaust temperature (° C.) | 110.48 | 115.65 | 110.95 | 113.22 | 128.31 | 110.12 |
| Heating quantity by mass | 83.64 | 102.38 | 100.54 | 100.27 | 118.13 | 100.27 |
| (kJ/kg) | | | | | | |
| Power consumption by | 33.31 | 38.84 | 36.84 | 37.47 | 47.86 | 33.51 |
| mass (kJ/kg) | | | | | | |
| Heating efficiency | 2.51 | 2.64 | 2.73 | 2.68 | 2.47 | 2.99 |
| Heating quantity by | 3057.54 | 3488.90 | 2836.54 | 3193.28 | 5520.67 | 2357.70 |
| volume (kJ/m³) | | | | | | |
| Compression ratio | 4.31 | 4.37 | 4.43 | 4.40 | 3.91 | 4.20 |
| Boiling point (° C.) | −7.80 | −8.77 | −2.17 | −5.97 | −26.36 | 3.25 |
| Exhaust pressure (bar) | 23.40 | 25.02 | 19.70 | 22.65 | 39.72 | 14.20 |
| Suction pressure (bar) | 5.43 | 5.72 | 4.45 | 5.14 | 10.17 | 3.38 |
| Condensation temperature | 1.16 | 2.59 | 0.38 | 2.21 | 0.00 | 0.00 |
| glide (° C.) | | | | | | |
| Evaporation temperature | 0.75 | 1.77 | 0.15 | 1.24 | 0.00 | 0.00 |
| glide (° C.) | | | | | | |
| ODP | 0 | 0 | 0 | 0 | 0 | 1 |
| GWP | 7197 | 6695 | 9227 | 7730 | 1300 | 9800 |

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

What is claimed is:

1. A working fluid for a heating and cooling, comprising a blend of from about 1% to about 98% by weight 1,1,1,2-tetrafluoroethane, from about 1% to about 98% by weight 1,1,1,2,3,3,3-heptafluoropropane, and from about 1% to about 98% by weight 1,1,1,3,3,3-hexafluoropropane, wherein the 1,1,1,2-tetrafluoroethane, 1,1,1,2,3,3,3-heptafluoropropane, and 1,1,1,3,3,3-hexafluoropropane comprise from about 90% or more by weight of the blend.

2. The working fluid of claim 1, comprising a blend of from about 2% to about 40% by weight 1,1,1,2,3,3,3-heptafluoropropane, from about 2% to about 40% by weight 1,1,1,3,3,3-hexafluoropropane, and from about 10% to about 85% by weight 1,1,1,2-tetrafluoroethane.

3. The working fluid of claim 1, comprising a blend of from about 10% to about 40% by weight 1,1,1,2,3,3,3-heptafluoropropane, from about 10% to about 40% by weight 1,1,1,3,3,3-hexafluoropropane, and from about 20% to about 70% by weight 1,1,1,2-tetrafluoroethane.

4. The working fluid of claim heptafluoropropane, 1, wherein the 1,1,1,2,3,3,3-heptafluoropropane, 1,1,1,3,3,3-hexafluoropropane, and 1,1,1,2-tetrafluoroethane comprise from about 95% or more by weight of the blend.

5. The working fluid of claim 1, wherein the blend further comprises up to about 10% by weight of a different hydrochlorofluorocarbon and/or a different hydrofluorocarbon.

6. The working fluid of claim 1, wherein the blend further comprises up to about 5% by weight of a hydrochlorofluorocarbon and/or a hydrofluorocarbon other than the foregoing.

7. A heating/cooling apparatus, comprising a compressor, a condenser, an expansion element, and an evaporator in series in a cycle, wherein the apparatus further comprises a working fluid of a blend of from about 1% to about 98% by weight 1,1,1,2,3,3,3-heptafluoropropane, from about 1% to about 98% by weight 1,1,1,3,3,3-hexafluoropropane, and from about 1% to about 98% by weight 1,1,1,2-tetrafluoroethane, wherein the 1,1,1,2,3,3,3-heptafluoropropane, 1,1,1,3,3,3-hexafluoropropane, and 1,1,1,2-tetrafluoroethane comprise from about 90% or more by weight of the blend.

8. The apparatus of claim 7, wherein the working fluid comprises a blend of from about 2% to about 40% by weight 1,1,1,2,3,3,3-heptafluoropropane, from about 2% to about 40% by weight 1,1,1,3,3,3-hexafluoropropane, and from about 10% to about 85% by weight 1,1,1,2-tetrafluoroethane.

9. The apparatus of claim 7, wherein the working fluid comprises a blend of from about 10% to about 40% by weight 1,1,1,2,3,3,3-heptafluoropropane, from about 10% to about 40% by weight 1,1,1,3,3,3-hexafluoropropane, and from about 20% to about 70% by weight 1,1,1,2-tetrafluoroethane.

10. The apparatus of claim 7, wherein 1,1,1,2,3,3,3-heptafluoropropane, 1,1,1,3,3,3-hexafluoropropane, and 1,1,1,2-tetrafluoroethane comprise about from 90% or more by weight of the blend.

11. The apparatus of claim 7, wherein the blend further comprises up to about 10% by weight of a different hydrochlorofluorocarbon and/or a different hydrofluorocarbon.

12. The apparatus of claim 7 which is a heat pump system.

13. The apparatus of claim 7 which is a refrigerator.

14. The apparatus of claim 7 which is a chiller.

15. A method for heating/cooling, comprising:
a) evaporating a working fluid in the form of a lower pressure liquid to form a lower pressure vapor;
b) compressing the lower pressure vapor to a higher pressure vapor;
c) condensing the higher pressure vapor to a higher pressure liquid;
d) expanding the higher pressure liquid to a lower pressure liquid; and
e) recycling the lower pressure liquid to step a),
wherein the working fluid comprises a blend of from about 1% to about 98% by weight 1,1,1,2,3,3,3-heptafluoropropane, from about 1% to about 98% by weight 1,1,1,3,3,3-hexafluoropropane, and from about 1% to about 98% by weight 1,1,1,2-tetrafluoroethane.

16. The method of claim 15, wherein the working fluid comprises a blend of from about 2% to about 40% by weight 1,1,1,2,3,3,3-heptafluoropropane, from about 2% to about 40% by weight 1,1,1,3,3,3-hexafluoropropane, and from about 10% to about 85% by weight 1,1,1,2-tetrafluoroethane.

17. The method of claim 15, wherein the working fluid comprises a blend of from about 10% to about 40% by weight 1,1,1,2,3,3,3-heptafluoropropane, from about 10% to about 40% by weight 1,1,1,3,3,3-hexafluoropropane, and from about 20% to about 70% by weight 1,1,1,2-tetrafluoroethane.

18. The method of claim 15, wherein the 1,1,1,2,3,3,3-heptafluoropropane, 1,1,1,3,3,3-hexafluoropropane, and 1,1,1,2-tetrafluoroethane comprise from about 90% or more by weight of the blend.

19. The method of claim 15, wherein the blend further comprises up to about 10% by weight of a hydrochlorofluorocarbon and/or a hydrofluorocarbon other than the foregoing.

20. A method of cooling, comprising evaporating a blend comprising from about 1% to about 98% by weight 1,1,1,2,3,3,3-heptafluoropropane, from about 1% to about 98% by weight 1,1,1,3,3,3-hexafluoropropane, and from about 1% to about 98% by weight 1,1,1,2-tetrafluoroethane, wherein the 1,1,1,2,3,3,3-heptafluoropropane, 1,1,1,3,3,3-hexafluoropropane, and 1,1,1,2-tetrafluoroethane comprise from about 90% or more by weight of the blend.

21. A method of heating, comprising condensing a blend comprising from about 1% to about 98% by weight 1,1,1,2,3,3,3-heptafluoropropane, from about 1% to about 98% by weight 1,1,1,3,3,3-hexafluoropropane, and from about 1% to about 98% by weight 1,1,1,2-tetrafluoroethane, wherein the 1,1,1,2,3,3,3-heptafluoropropane, 1,1,1,3,3,3-hexafluoropropane, and 1,1,1,2-tetrafluoroethane comprise from about 90% or more by weight of the blend.

22. The working fluid of claim 1 further comprising a lubricant.
